(19) United States
(12) Patent Application Publication
(10) Pub. No.: US 2013/0126416 A1
(43) Pub. Date: May 23, 2013

(54) Urea-Water Solution Filter System

(71) Applicant: MANN+HUMMEL GMBH, Ludwigsburg (DE)

(72) Inventors: Martin Weindorf, Kornwestheim (DE); Bernd Nageldinger, Asperg (DE); Markus Nefzer, Ludwigsburg (DE)

(73) Assignee: MANN+HUMMEL GMBH, Ludwigsburg (DE)

(21) Appl. No.: 13/740,213

(22) Filed: Jan. 13, 2013

Related U.S. Application Data
(63) Continuation of application No. PCT/EP2011/061414, filed on Jul. 6, 2011.

(30) Foreign Application Priority Data
Jul. 13, 2010 (DE) 10 2010 027 069.5

(51) Int. Cl. B01D 35/31

(52) U.S. Cl. CPC B01D 35/31
USPC 210/444; 210/483; 210/493.1; 210/493.2; 210/435

(57) ABSTRACT

A urea-water solution filter (1) comprising a housing (2), a cover (3) and a urea-water solution filter element (4), wherein a membrane (8) separates a compensation volume (10) from a filtration volume (11) and the membrane (8) seals between cover (3) and housing (2).

### CROSS REFERENCE TO RELATED APPLICATIONS

This application is US Bypass Continuation of international patent application no. PCT/EP2011/061414 filed: Jul. 6, 2011 designating the United States of America, the entire disclosure of which is incorporated herein by reference. Priority is claimed based on German patent application no. 10 2010 027 069.5 filed Jul. 13, 2010.

### TECHNICAL FIELD

The invention is in the field of liquid filtration, in particular urea filtration.

### BACKGROUND OF THE INVENTION

The exhaust-gas limit values in the automobile sector require technical solutions to minimize pollution. Besides the threshold values for carbon monoxide (CO), hydro-carbons (HC), and particles (PM), for which there are solutions in the form of three-way catalytic converters and soot particle filters, the focus is put on the nitrogen oxides. For an efficient nitrogen oxide removal, so-called SCR catalysts (Selective Catalytic Reduction) have been developed for applications in commercial vehicles as well as in passenger cars. By adding ammonia, this catalyst transforms nitrogen oxides into nitrogen and water by chemical reduction. Besides the pure catalyst function, further system components are needed. The liquid reducing agent (urea-water solution) needs to be sufficiently cleaned from impurities. This is done by means of urea-water solution filters of different design.

The proper operation of the SCR system requires a sufficient reliability of the materials towards urea-water solution. Furthermore, it must be ensured that no compounds that are harmful to catalysts are contained in the SCR components. Thus, e.g. Viton or, possibly modified, EPDM can be used as sealing compound. When using synthetic materials, it has to be taken care that no harmful additives (resulting from manufacturing and machining of the synthetic materials) are included. The operating temperatures of the urea-water solution filters are at −40° C. up to 80° C., for a short time at max. 90° C.

The injection system of the SCR system can react critically to impurities and contaminant particles. Particle sources are, for example, impurities from the urea-water solution, wear particles and particles generated in the metering unit (e.g. pump) which are introduced into the system (e.g. urea-water solution filling process and tank ventilation). The object of the filter used is to protect the components of the SCR system from wear and failure. As a necessary filtration grade, a filtration grade (βx=100) of 10 μm has proven its worth.

A very particular challenge in the development of SCR systems is to make the systems icing-resistant. The urea-water solution as a 32.5% mixture does not freeze like water at 0° C., but at approximately −11° C. An ice-resistant solution can be obtained by supplying heat from the outside, e.g. by means of electrical heating systems and engine heat. In the second case, this only works when the vehicle is in operating condition. If a vehicle is parked in cold weather, the urea-water solution has to be removed from the system to a large extent (e.g. by pumping it down, by blowing it off). Alternatively, the components have to be designed such that they resist to the generated ice pressure. As enormous forces develop because of the ice pressure when a solution freezes in a closed container, it needs to be considered how the resulting pressure can be compensated.

To reach the ice resistance, different solutions can be realized. For example, the ice pressure is absorbed by so-called compensating elements. The volume that is enlarged (approx. 10%) due to the freezing of the urea-water solution is absorbed or compensated, respectively, by these compensating elements. Also possible are compensating tanks on the housing side or elastic housing components, respectively. It is, moreover, important that the corresponding liquid volume of the urea-water solution in the system components is kept as low as possible. It should be designed in such a way that no or only a small dead space volume exists.

From EP 1 510 239 B1 is, for example, known a filtering device for liquid filtration that has in the filter housing an elastically deformable expansion element, the deformation of which influences the volume of at least one section of the flow path of the liquid to be cleaned. This expansion element can elastically yield under the pressure of the liquid, so that the space within the filter housing can be enlarged on that side of the filter element that is in contact with the liquid. In particular in the case that the supplied medium freezes at low temperatures and expands, the expansion element ensures, thanks to its deformability, that the available volume is enlarged so that the extremely high forces generated during the freezing process are not immediately directed towards the filter element and, therefore, can not lead to a destruction of the filter element. The deformability of the expansion element prevents an inadmissibly high force transmission to the filter element. The filter housing, too, is protected by the expansion element against inadmissibly high forces, which could lead to a destruction and leakage of the filter housing.

The object of the invention is to improve such a filter element in that the assembly and the service of the filter element are facilitated. Another object is the substitution of an expansion element as in EP 1 510 239 B, which is, for example, a foamed compensating element, by a membrane solution. Another object is to secure the replacement of the sealing during a filter element replacement.

### SUMMARY OF THE INVENTION

An object of the present invention is to improve such a filter element in that the assembly and the service of the filter element are facilitated. Another object is the substitution of an expansion element as in EP 1 510 239 B, which is, for example, a foamed compensating element, by a membrane solution. Another object is to secure the replacement of the sealing during a filter element replacement.

These and further objects are solved by a urea-water solution filter comprising a housing, a cover and a urea-water solution filter element with a membrane being attached to the urea-water solution filter element, wherein the membrane separates a compensation volume from a filtration volume and the membrane is designed for sealing between the cover and the housing.

These and further objects are solved by a urea-water solution filter with a membrane being attached to the urea-water solution filter element, wherein the membrane is capable of separating a compensation volume from a filtration volume and to function as sealing between the cover and the housing.

As the membrane forms the sealing of cover and housing towards the outside and is attached to the filter element, the sealing is replaced together with the filter element.

The membrane can be attached detachably or undetachably at the filter element. For example, the membrane can be injection molded or glued, tied up or plugged on to the filter element.

The membrane is at least fixed at the sealing area between cover and housing. If the urea-water solution in the filter expands during freezing, the membrane can then de-form towards the inside of the compensation volume and thus enlarge the filtration volume. In this case, the membrane remains fixed at the sealing area between cover and housing.

In various embodiments, the membrane is supported by support members in the compensation volume. The support can be realized in undeformed state. For example, the membrane can be supported approximately centrally by a. for example central, support member in the compensation volume. The support can also be realized in deformed state, e.g. by various support members initially in deformed state, but not yet in undeformed state.

In one embodiment, the urea-water solution filter element can be attached to the cover in such a way that it can be removed together with the cover. To do this, for example, a snap fitting, a friction locking, a bayonet or screwed connection between urea-water solution filter element and cover can be realized.

In one embodiment, the urea-water solution filter element is a hollow cylindrical filter element with a star-pleated bellows.

The star-pleated bellows can be provided with plastic end plates and/or glued at the end face edges. A so called foil end plate made of elastic material can be attached.

The membrane can then be connected with the filter element via the end plate.

For stabilization, the hollow-cylindrical urea-water solution filter element can be provided with an inner tube and/or an outer tube.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

Features of the present invention, which are believed to be novel, are set forth in the drawings and more particularly in the appended claims. The invention, together with the further objects and advantages thereof, may be best understood with reference to the following description, taken in conjunction with the accompanying drawings. The drawings show a form of the invention that is presently preferred; however, the invention is not limited to the precise arrangement shown in the drawings.

FIG. 1 is a schematic block diagram of a SCR system, consistent with the present invention;

FIG. 2 depicts a urea-water solution filter system with a membrane in undeformed (1) and in deformed (2) state, consistent with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

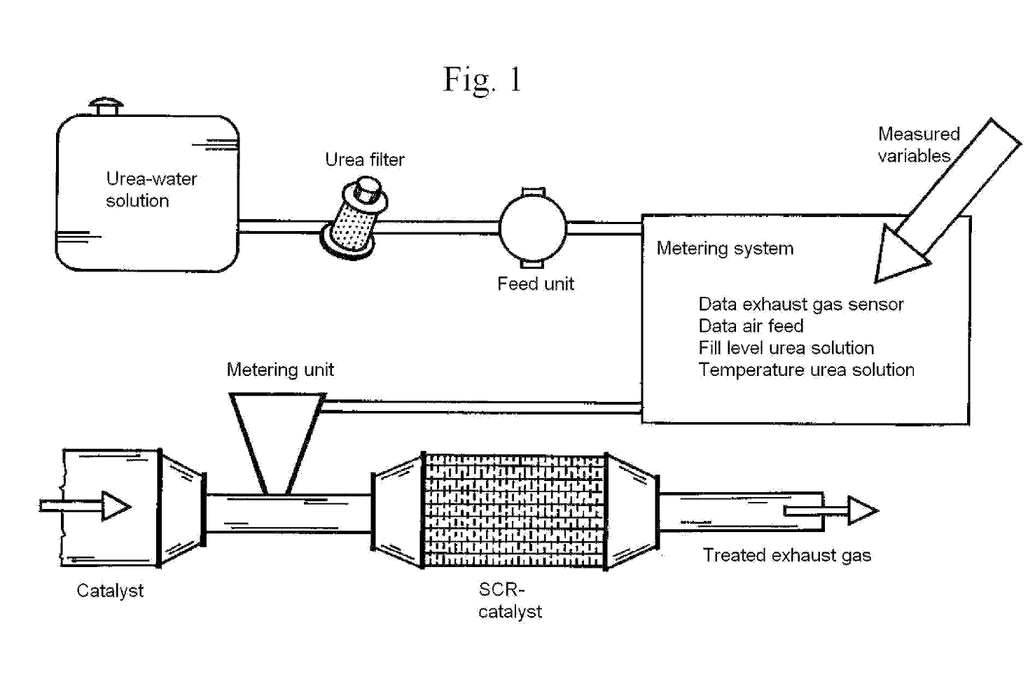

FIG. 1 shows a schematic SCR system as an example. The system consists primarily of the components tank for the aqueous urea solution, urea filter, feed unit, metering system or metering unit, SCR catalyst and control unit.

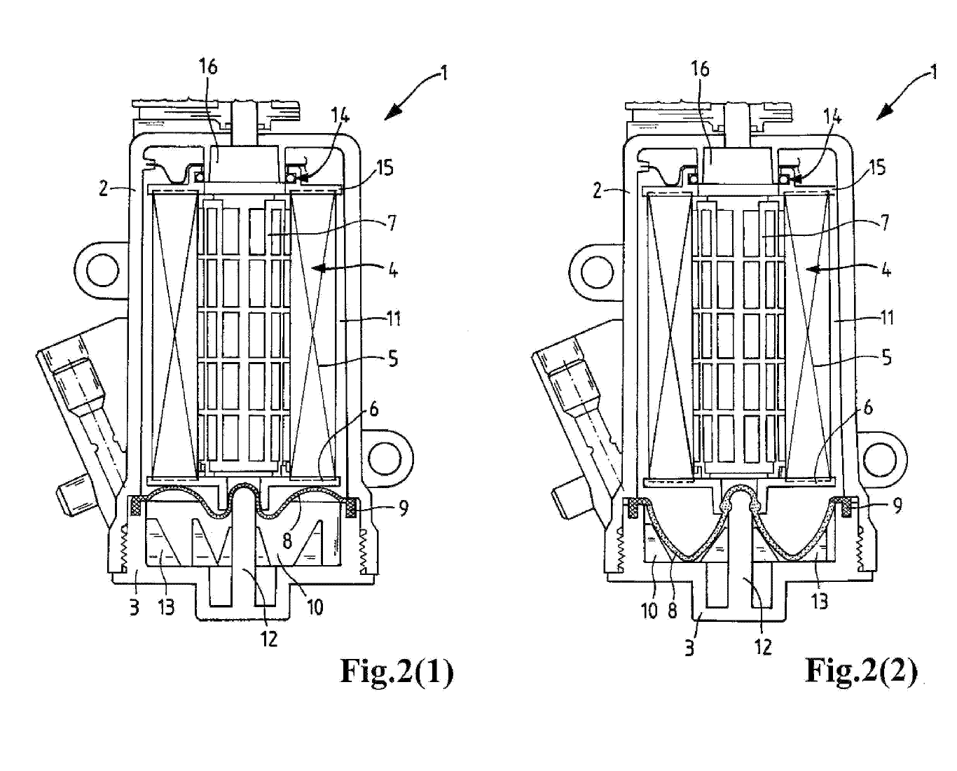

FIG. 2 shows a urea-water solution filter system 1, comprising a housing 2 and a cover 3. The urea-water solution filter system 1 comprises a urea-water solution filter element 4, which is designed as hollow-cylindrical filter element. The urea-water solution filter element 4 comprises a bellows 5 which is star-pleated. The bellows can comprise a cellulose-based filter medium, which is, for example, acrylic- or epoxy-impregnated. As an alternative, the bellows 5 can also be designed as plastic medium, e.g. polypropylene meltblown. The bellows 5 is supported by an inner tube 7.

One end of the bellows 5 is closed by an end plate 6. A membrane 8 is tied to the end plate 6. The membrane forms a circumferential sealing 9 between cover 3 and housing 2. The sealing 9 can, for example, be a thickening of the membrane 8.

The membrane separates a compensation chamber 10 from a filtration chamber 11. In FIG. 1, the membrane 8 is undeformed. In FIG. 2, the membrane 8 is de-formed, e.g. by liquid expanding in the filtration chamber, e.g. by freezing of the urea-water solution which results in a volume expansion. Due to the deformation of the membrane 8, the filtration volume is enlarged and the compensation volume is reduced.

In the example of FIG. 2, the membrane 8 is in the area where it is tied to the end plate 6 deformed towards the inside in such a way that a snap fitting of the cover 3 with the urea-water solution filter element 4 can be obtained in this area by means of a support 12. Supports 13 in the cover can limit the deformation of the membrane 8 during the expansion of the liquid or the ice, respectively, in the filtration volume.

Cover 3 and housing 4 are screwed in the example of the FIG. 2. Other connections, such as bayonet coupling, can also be conceived.

At the second end plate 15, an outlet 16 is connected with the inside of the urea-water solution filter element 4 via an o-ring 14. In case of another flow guidance, an inlet can also be connected here.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims The invention is defined solely by the appended claims including any amendments made during the pendency of this application and all equivalents of those claims as issued.

1. A urea-water solution filter element, comprising:
a membrane able to separate in a urea-water solution filter a compensation volume from a filtration volume and to seal between a cover and a housing of a urea-water solution filter.

2. The urea-water solution filter element according to claim 1, wherein
the membrane is injection molded or glued, tied up or plugged onto the filter element.

3. The urea-water solution filter element according to claim 1
wherein the urea-water solution filter element is a hollow cylindrical filter element with a star-pleated bellows.

4. The urea-water solution filter element according to claim 2
wherein the urea-water solution filter element is a hollow cylindrical filter element with a star-pleated bellows.

5. The urea-water solution filter element according to claim 4, wherein
the star-pleated bellows includes plastic end plates secured to or glued at the end face edges of the star-pleated bellows.

6. A urea-water solution filter comprising:
a housing;
a cover;
a urea-water solution filter element according to claim 1;
wherein the membrane separates a compensation volume from a filtration volume;
wherein the membrane seals between the cover and the housing.

7. The urea-water solution filter according to claim 6, wherein
the urea-water solution filter element is detachably secured to the cover;
wherein the means of detachably securing the filter element to the cover is any of: a snap fitting, a friction locking, a bayonet or a screwed connection;
wherein the detachable securing means secures the filter element to the cover such that the filter element is removed from the housing while remaining secured to the cover as a one-piece unit.
